(19) United States
(12) Patent Application Publication
(10) Pub. No.: US 2004/0176132 A1
(43) Pub. Date: Sep. 9, 2004

(54) Appliance control system

(76) Inventor: Steven Thrasher, Richardson, TX (US)

Correspondence Address: Steven Thrasher, 391 Sandhill Dr., Richardson, TX, 75080, US

(21) Appl. No.: 10/794,651

(22) Filed: Mar. 4, 2004

Related U.S. Application Data
(60) Provisional application No. 60/451,727, filed on Mar. 4, 2003.

(51) Int. Cl. H04M 1/00

(52) U.S. Cl. 455/556.1

(57) ABSTRACT

The invention provides systems, devices and methods for muting appliances when an incoming call is detected.

### RELATED APPLICATION

This patent application is related to, and claims priority from co-owned and assigned U.S. Provisional Patent Application No. 60/451,727 to Thrasher, entitled APPLIANCE CONTROL SYSTEM, filed on Mar. 4, 2003.

### TECHNICAL FIELD OF THE INVENTION

The invention relates to telephones and appliances, more particularly, the invention relates to appliances that produce a sound.

Problem Statement

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

In the course of day-to-day activities persons are bombarded with a variety of sounds from appliances such as a television, a stereo, a compact disc player, DVD player, or a washer or dryer, for example. Whether or not one finds these sounds pleasant, one is frequently frustrated by these sounds in trying to focus attention on a person or other source of information while these sounds are in progress. In fact, such sound confusion is parodied in commercials such as those for Calgon (™) Bass. Accordingly, there are needed systems and methods for controlling noise from appliances when a more desirable source of information needs attention. The present invention provides such systems and methods.

### BRIEF DESCRIPTION OF THE FIGURES

Various aspects of the invention, as well as an embodiment, are better understood by reference to the following detailed description. To better understand the invention, the detailed description should be read in conjunction with the drawings in which:

FIG. 1 is a block diagram of an appliance control system;

FIG. 2 illustrates a method of controlling an appliance; and

FIG. 3 is a block diagram of a method for automatically detecting an appliance and registering the appliance with an appliance control system.

### EXEMPLARY EMBODIMENT OF A BEST MODE

The invention provides technical advantages as systems and methods for activating a mute function of an appliance when an incoming telephone call is received via a plain old telephone system or a cell phone or another telecommunications device. In an alternative embodiment, the invention provides means for temporarily disabling an appliance, such as a washer or dryer, when the incoming telecommunications are received.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the claims section. Sixth, the invention is also described in view of the Festo decisions, and, in that regard, the claims and the invention incorporate equivalents known, foreseeable, and unforeseeable. Seventh, the interpretation of the language and the interpretation of each word herein, including especially in the claims, should be given the ordinary plain meaning and interpretation, unless indicated otherwise.

Computer Systems as Software Platforms

A computer system typically comprises hardware capable of executing machine-readable instructions, as well as software for executing acts typically as machine-readable instructions that produce a desired result. In addition, a computer system may include hybrids of hardware and software, as well as computer sub-systems.

Software may be defined as machine code stored in memory, such as RAM or ROM, or machine code stored on devices (such as memory card, for example). Software may include executable code, an operating system, or source or object code, for example. In addition, software encompasses any set of instructions capable of being executed in a client machine or server—and, in this form, is often called a program or executable code.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes called an act. Accordingly, software may be used to perform a method that comprises acts. In the present discussion, sometimes acts are referred to as steps to help the reader more completely understand the exemplary embodiment.

Software also includes description code. Description code specifies variable values and uses these values to define attributes for a display, such as the placement and color of an item on a displayed page. For example, the Hypertext Transfer Protocol (HTTP) is the software used to enable the Internet and is a description software language.

Hybrids (combinations of software and hardware) are becoming more common as devices for providing enhanced functionality and performance to computer systems. A hybrid is created when traditionally software functions are directly manufactured into a silicon chip-this is possible since software may be assembled and compiled into ones and zeros, and, similarly, ones and zeros can be represented directly in silicon. Typically, the hybrid (manufactured hardware) functions are designed to operate seamlessly with software. Accordingly, it should be understood that hybrids and other combinations of hardware and software are also included within the definition of a computer system and are thus envisioned by the invention as possible equivalent structures and equivalent methods.

Handheld computer sub-systems are combinations of hardware or software (or hybrids) that perform some specific task. For example, one computer subsystem is a soundcard. For example, a soundcard provides hardware connections, memory, and hardware devices for enabling sounds to be produced and recorded by a computer system. Likewise, a soundcard may also include software needed to enable a computer system to “see” the soundcard, recognize the soundcard, and drive the soundcard.

Methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

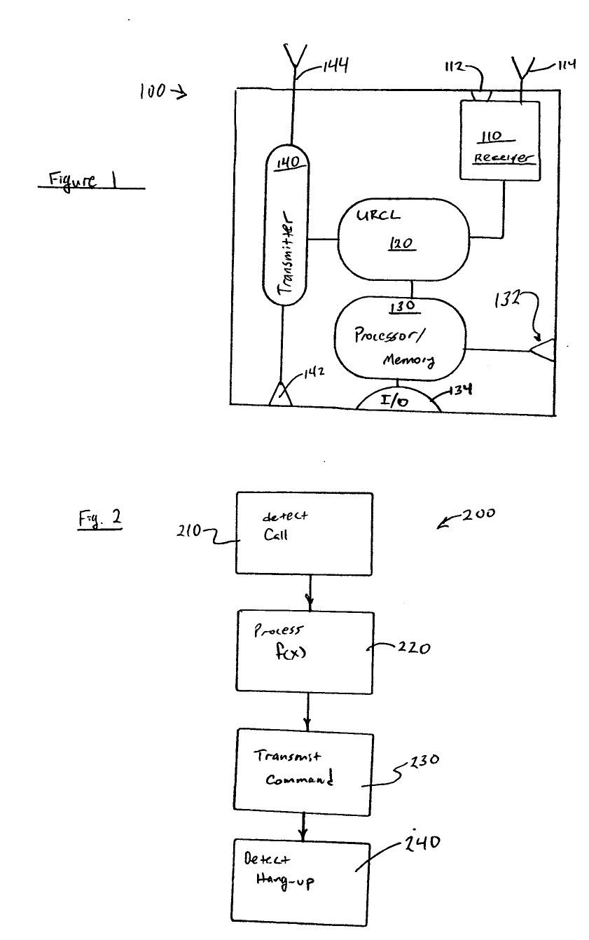

FIG. 1 is a block diagram of an appliance control system 100. The appliance control system 100 generally comprises a means for detecting an incoming call (receiver) 100, a transmitter 140, a universal remote control logic (URCL) 120 that is adapted to control an appliance (which is preferably a home appliance) and coupled between the means for detecting an incoming call 110 and the transmitter 140. The means for detecting an incoming call is preferably communicatively coupled to a telephone network, and detects an incoming phone call, as well as different phases of a phone call (hand-set pickup or equivalent, and hand-set hang-up or equivalent, for example, as is known in the telephone arts). In one embodiment, the means for detecting an incoming call 110 comprises a plain old telephone system (POTS) receiver coupled between a jack 112 and the URCL 120. Alternatively, the means for detecting an incoming call 110 may comprise a wireless receiver, such as a cell phone receiver or a satellite receiver, for example, coupled between a radio antenna 114 and the URCL 120.

The transmitter 140 is adapted to allow the system to communicate with an appliance, and comprises the circuitry needed to transmit a signal to an appliance, such as a home appliance, as well as a transmitting subcomponent, such as an infrared transmitter 142 or a radio frequency transmitter 144, for example. Likewise, the universal remote control logic (URCL) 120 comprises hardware and software for communicating with an appliance. Preferably, the URCL 120 stores remote control “codes” that are registered with the appropriate standards agency, as is known in the remote control arts.

In addition, the URCL 120 is programmable to receive additional codes-such programming may be achieved via a processor 130 coupled to the URCL 120, where the processor is controlled via a user input/output device 134, or a computing device coupled to the port 132. The processor comprises logic adapted to communicate with a personal computer operating system, and, in a preferred embodiment, is also adapted to control the URCL. Accordingly, the URCL 120 can be programmed to accommodate additional appliances, such as stereos, televisions, or video recorders, for example. Accordingly, the URCL 120 may functionally receive an indication of a call from the means for detecting an incoming call 110, then in response to the detected incoming phone call, associates at least an appliance with a command, such as a mute or pause command, for example.

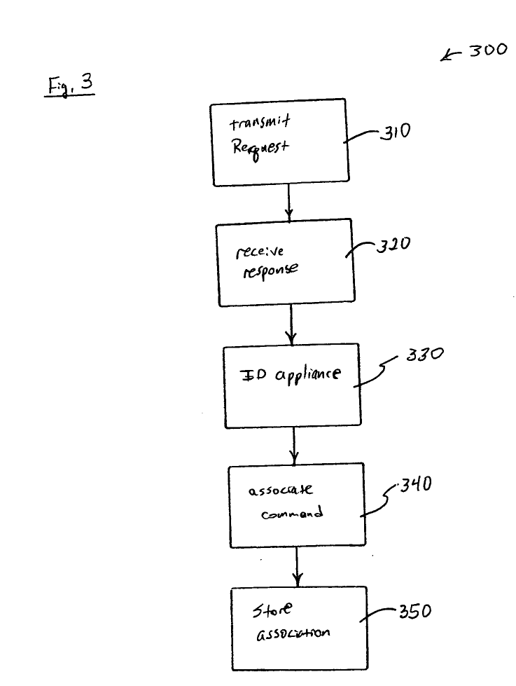

FIG. 2 illustrates a method of controlling an appliance as a control algorithm 200. The control algorithm 200 controls an appliance in response to an incoming telecommunications signal, and generally comprises the acts of detecting an incoming phone call 210, processing a home appliance control function to generate a command (process function) 220, and transmitting the command to an appliance (transmit command) 230. Accordingly, the control algorithm 200 begins with a detect call act 210 in which a phone call is detected. The phone call may be outgoing (by detecting the picking-up of a handset), or incoming. The control algorithm 200 may be adjusted to, for incoming calls, respond to either the detecting of the fact that a call is being received, or to respond to the actual picking up of a handset to answer the incoming call. In either case, such detection is well known in the telecommunications arts, and is widely used in answering machine and call-notes systems. Common means for detecting an incoming phone call include means that detect calls coming in from a plain old telephone system (POTS), as well as wireless systems such as satellite systems and cell phone systems, for example.

Next, in a processor function act 220 a URCL or a processor accepts an indication of an incoming phone call and, in response to the indication, selects the proper signaling needed to achieve the desired appliance function, such as a mute or pause command, for example, and also selects the signaling system and codes needed (if any) to command the appliance, such as a radio, stereo, or television, for example, as desired. The processing power provides a user the ability to program an appliance control system to detect in incoming phone call, and to transmit a command to cause a specific response in a specific appliance, and such functionality is preferably achieved by programming the system via the URCL or the processor prior to an execution of the control algorithm 200.

Following the processor function act 220, the control algorithm 200 proceeds to a transmit command act 230 in which an appliance control system transmits the appropriate command sequence in the appropriate command code(s) via wireless signals, such as infrared or wireless signals. Next, in a hang-up act 240, the means for detecting an incoming phone call detects that a phone call has been terminated. In response to detecting that the phone call has been terminated, such as by detecting that a handset has been hung-up, the appliance control system may un-pause an appliance(s), un-mute an appliance(s), or otherwise return an appliance to the state (or performance state) the appliance had prior to detecting an incoming phone call.

Several variations of the disclosed method exist, both foreseeable and presently unforeseeable, and both are incorporated within the scope of the invention. For example, the control algorithm 200 may comprise the act of transmitting a plurality of commands to a plurality of home appliances. In addition, the control algorithm 200 may comprise the act of transmitting an all-mutes command that “blast” mute commands based on all known devices, or based on all channels and all protocols for all devices (or some variation thereof), and/or an all-pauses command that “blast” pause commands based on all known devices, or based on all channels and all protocols for all devices (or some variation thereof). Of course, many alternative preferred methods are, upon reading the present disclosure, apparent to those of ordinary skill in the art, and such variations are incorporated into the invention, which is limited only by the claims.

FIG. 3 is a block diagram of a method for automatically detecting an appliance and registering the appliance with an appliance control system as programming algorithm 300. The programming algorithm 300 begins with a transmit request act 310, in which the programming algorithm transmits an identify command. The transmission of transmit request act 310 may be in response to a user input, a “cold-boot”, or another user-initiated or automatic command. After the transmit request act 310, in a receive response act 320, the programming algorithm 300 receives a response from an appliance that identifies the appliance, which is preferably a home appliance, but could also be a transportable appliance such as a boom-box or a motor vehicle audio system, for example.

Next, an ID appliance act 330 identifies the appliance from which the signal was received. The identification of the appliance can be unique to the appliance, or may comprise an identification of a family of appliances (this may largely depend on a device's manufacturer). Following the identification of the appliance, the programming algorithm 300 associates a predefined appliance command with the appliance. In one embodiment, the predefined appliance command is a mute command, and in another embodiment it is a pause command, though it could be both commands or similar appliance commands. Next, in an associate command 340, the programming algorithm 300 stores in a memory the relationship between the appliance and the predefined appliance command.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modification.

What is claimed is:

1. An appliance control system, comprising:
a means for detecting an incoming call;
a transmitter;
a universal remote control logic (URCL) that is adapted to control a home appliance; and
the URCL coupled between the means for detecting an incoming call and the transmitter.

2. The appliance control system of claim 1 wherein the means for detecting an incoming call comprises a plain old telephone system (POTS) receiver coupled between a jack and the URCL.

3. The appliance control system of claim 1 wherein the transmitter comprises an infrared transmitter.

4. The appliance control system of claim 1 wherein the transmitter comprises a radio frequency transmitter.

5. The appliance control system of claim 1 wherein the universal remote control logic is programmable.

6. The appliance control system of claim 1 wherein the means for detecting an incoming call is a wireless receiver.

7. The appliance control system of claim 6 wherein the wireless receiver is a satellite receiver.

8. The appliance control system of claim 1 further comprising a processor coupled to the URCL.

9. The appliance control system of claim 1 further comprising a processor coupled to the URCL, the processor comprising logic adapted to communicate with a personal computer operating system, and the processor also adapted to control the URCL.

10. A method of controlling an appliance in response to a telecommunications signal, comprising:
detecting a phone call;
processing a home appliance control function to generate a command; and
transmitting the command to a home appliance.

11. The method of claim 10 wherein the home appliance is a television.

12. The method of claim 10 wherein the phone call is an incoming phone call.

13. The method of claim 10 wherein the telecommunications signal is a telephone call received through a plain old telephone system (POTS).

14. The method of claim 10 wherein the home appliance control function is a mute function.

15. The method of claim 10 wherein the home appliance control function is a pause function.

16. The method of claim 10 further comprising programming an appliance control system to detect in incoming phone call, and transmit a command for a specific appliance.

17. The method of claim 10 further comprising transmitting a plurality of commands to a plurality of home appliances.

18. The method of claim 11 further comprising transmitting an all-mutes command and an all-pauses command.

19. A method of automatically programming an appliance control system, comprising:
transmitting an identify command;
receiving a response from an appliance that identifies the appliance;
identifying the appliance from which the signal was received;
associating a predefined appliance command with the appliance; and
storing in a memory the relationship between the appliance and the predefined appliance command.

20. The method of claim 19 further comprising associating a mute command with the appliance.
